(19) United States
(12) Patent Application Publication
(10) Pub. No.: US 2018/0088384 A1
(43) Pub. Date: Mar. 29, 2018

(54) LIQUID CRYSTAL DISPLAY PANEL AND MANUFACTURING METHOD THEREOF

(71) Applicant: Shenzhen China Star Optoelectronics Technology Co., Ltd., Shenzhen City (CN)

(72) Inventor: Qiming Gan, Shenzhen City (CN)

(21) Appl. No.: 15/031,748

(22) PCT Filed: Apr. 8, 2016
(86) PCT No.: PCT/CN2016/078881

§ 371 Date: Apr. 24, 2016

(30) Foreign Application Priority Data
Mar. 10, 2016 (CN) 201610136203.2

(51) Int. Cl. G02F 1/1339; G02F 1/1335; G02F 1/1343; G02F 1/1368; G02F 1/1341

(52) U.S. Cl. CPC G02F 1/13394; G02F 1/133512; G02F 1/133514; G02F 1/134309; G02F 2001/136222; G02F 1/1341; G02F 2001/13398; G02F 2001/134318; G02F 1/1368

(57) ABSTRACT

The present invention provides a liquid crystal display panel and a manufacturing method thereof, in which aligned carbon nanotube arrays are provided to replace photo spacers that are used in the prior art and takes advantage of the excellent mechanic property and excellent stability of the aligned carbon nanotubes to significantly enhance the performance and service life of a liquid crystal display panel. The manufacturing method of the liquid crystal display panel of the present invention grows aligned carbon nanotubes on one substrate of a liquid crystal display panel to obtain spacers formed of aligned carbon nanotube arrays, so as to take advantage of the excellent mechanic property and excellent stability of the aligned carbon nanotubes to significantly enhance the performance and service life of a liquid crystal display panel.

### BACKGROUND OF THE INVENTION

### 1. Field of the Invention

The present invention relates to the field of display technology, and in particular to a liquid crystal display panel and a manufacturing method thereof.

### 2. The Related Arts

With the progress of the display technology, flat panel display devices, such as liquid crystal displays (LCDs), due to a variety of advantages, such as high image quality, low power consumption, thin device body, and wide application, have been widely used in various consumer electronic products, such as mobile phones, televisions, personal digital assistants (PDAs), digital cameras, notebook computers, and desktop computers, making them the main stream of display devices.

Most of the liquid crystal display devices that are currently available in the market are backlighting LCDs, which comprise a liquid crystal display panel and a backlight module. The working principle of the liquid crystal display panel is that liquid crystal molecules are arranged between two parallel glass substrates with a number of vertical and horizontal tiny electrical wires arranged between the two glass substrates and the liquid crystal molecules are controlled to rotate according to whether electricity is applied or not so as to refract out light from the backlight module to generate an image.

FIG. 1 is a schematic view illustrating the structure of a conventional liquid crystal display panel. The liquid crystal display panel comprises an upper substrate 100 and a lower substrate that are arranged opposite to each other, a liquid crystal layer 400 arranged between the upper substrate 100 and the lower substrate 200, and a plurality of photo spacers 300 arranged between the upper substrate 100 and the lower substrate 200. The photo spacers 300 are made of a photoresist material. Due to instability of property, the photoresist material reacts easily with other substances and shows poor mechanic performance. Thus, when the photo spacers 300 react with other substances of the liquid crystal display panel or undergoes deformation, the performance and displaying effect of the liquid crystal display panel are easily affected.

Carbon nanotube (CNT) is formed by wrapping a single layer or multiple layers of graphite sheet, having a diameter of some tens of nanometers and a length of several to tens micrometer. The carbon nanotube has extremely stable property, is resistant to high temperature, is extremely hard to react with other substances, has excellent mechanic property, and shows excellent elastic property of compression and restorability. Compared to disorderly stacked carbon nanotube clusters, aligned carbon nanotubes show similar growth directions and may easily form a carbon nanotube array. Thus, the conventionally used photo spacers can be substituted by formation of aligned carbon nanotube arrays by growing aligned carbon nanotubes on one substrate of a liquid crystal display panel at the locations originally designated for the spacers and the performance and service life of the liquid crystal display panel can be effectively enhanced with the excellent mechanic property and excellent stability of the aligned carbon nanotubes.

### SUMMARY OF THE INVENTION

An object of the present invention is to provide a liquid crystal display panel, which comprises aligned carbon nanotube array to substitute photo spacers used in the prior art and takes advantage of the excellent mechanic property and the excellent stability of the aligned carbon nanotubes to significantly improve the performance and service life of the liquid crystal display panel.

Another object of the present invention is to provide a manufacturing method of a liquid crystal display panel, which comprises growing aligned carbon nanotubes on one substrate of a liquid crystal display panel at locations designated for spacers so as to obtain spacers formed of aligned carbon nanotube arrays and takes advantage of the excellent mechanic property and the excellent stability of the aligned carbon nanotubes to significantly improve the performance and service life of the liquid crystal display panel.

To achieve the above objects, the present invention provides a liquid crystal display panel, which comprises an upper substrate and a lower substrate arranged opposite to each other, a liquid crystal layer arranged between the upper substrate and the lower substrate, and a plurality of spacers arranged between the upper substrate and the lower substrate, wherein the spacers are each formed of an aligned carbon nanotube array comprising multiple aligned carbon nanotubes that are arranged parallel to each other.

The aligned carbon nanotubes are single-walled carton nanotubes or a multi-walled carbon nanotubes.

The upper substrate comprises a first base plate, a black matrix arranged on the first base plate, and a color resist layer arranged on the black matrix and the first base plate. The color resist layer has a surface that is a flat and smooth surface. The lower substrate is a thin-film transistor array substrate.

The upper substrate comprises a first base plate and a patternized common electrode arranged on the first base plate. The plurality of spacers is arranged to contact portions of the first base plate that are not covered by the common electrode. The surface of the first base plate that is in contact with the plurality of spacers is a flat and smooth surface. The lower substrate comprises a second base plate and a gate electrode, a gate insulation layer, an active layer, source/drain electrodes, a passivation layer, a color resist layer, and a pixel electrode that are arranged, in sequence from bottom to top, on the second base plate

The present invention also provides a manufacturing method of a liquid crystal display panel, which comprises the following steps:

(1) providing a upper substrate, wherein the upper substrate comprises a first base plate, a black matrix arranged on the first base plate, and a color resist layer arranged on the black matrix and the first base plate, the color resist layer having a surface that is a flat and smooth surface; and the surface of the color resist layer is provided with a plurality of locations for spacers;

(2) growing aligned carbon nanotubes on the color resist layer at the plurality of locations for spacers such that in each of the locations for spacers, an aligned carbon nanotube array that comprises multiple parallel aligned carbon nanotubes is formed so as to form a plurality of spacers; and

(3) providing a lower substrate, wherein the lower substrate is a thin-film transistor array substrate; and dripping liquid crystal molecules on a surface of the upper substrate that comprises the plurality of spacers formed thereon or a surface of the lower substrate to form a liquid crystal layer and aligning and laminating the upper substrate and the lower substrate together to form a liquid crystal display panel.

The aligned carbon nanotubes are single-walled carton nanotubes or a multi-walled carbon nanotubes.

The plurality of spacers is arranged at locations corresponding to the black matrix of the upper substrate.

The present invention further provides a manufacturing method of a liquid crystal display panel, which comprises the following steps:

(1) providing a upper substrate, wherein the upper substrate comprises a first base plate and a patternized common electrode formed on the first base plate, a surface of the first base plate that is in contact with the common electrode being a flat and smooth surface, portions of the first base plate that are covered by the common electrode forming a plurality of locations for spacers;

(2) growing aligned carbon nanotubes on the first base plate at the plurality of locations for spacers, wherein each of the locations for spacers comprises an aligned carbon nanotube array comprising multiple parallel aligned carbon nanotubes formed thereon so as to form a plurality of spacers; and

(3) providing a lower substrate, wherein the lower substrate comprises a second base plate and a gate electrode, a gate insulation layer, an active layer, source/drain electrodes, a passivation layer, a color resist layer, and a pixel electrode that are arranged, in sequence from bottom to top, on the second base plate;

wherein liquid crystal molecules are dripped on a surface of the upper substrate that comprises the plurality of spacers formed thereon or a surface of the lower substrate that comprises the pixel electrode formed thereon to form a liquid crystal layer and the upper substrate and the lower substrate are aligned and laminated together to form a liquid crystal display panel.

The aligned carbon nanotubes are single-walled carton nanotubes or a multi-walled carbon nanotubes.

The common electrode is formed of a material comprising a metal; the lower substrate further comprises a black matrix arranged above or under the color resist layer; and the plurality of spacers is arranged at locations corresponding to the black matrix.

The efficacy of the present invention is that the present invention provides a liquid crystal display panel, which comprises aligned carbon nanotube arrays to replace photo spacers that are used in the prior art and takes advantage of the excellent mechanic property and excellent stability of the aligned carbon nanotubes to significantly enhance the performance and service life of a liquid crystal display panel. The present invention also provides a manufacturing method of a liquid crystal display panel, which grows aligned carbon nanotubes on one substrate of a liquid crystal display panel to obtain spacers formed of aligned carbon nanotube arrays, so as to take advantage of the excellent mechanic property and excellent stability of the aligned carbon nanotubes to significantly enhance the performance and service life of a liquid crystal display panel.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view illustrating the structure of a conventional liquid crystal display panel;

FIG. 2 is a schematic view illustrating the structure of a liquid crystal display panel according to a second embodiment of the present invention;

FIG. 3 is a schematic view illustrating the structure of a liquid crystal display panel according to a first embodiment of the present invention;

FIG. 4 is a schematic view illustrating step 1 of a manufacturing method of a liquid crystal display panel according to a first embodiment of the present invention;

FIG. 5 is a schematic view illustrating step 2 of the manufacturing method of the liquid crystal display panel according to the first embodiment of the present invention;

FIG. 6 is a schematic view illustrating step 1 of a manufacturing method of a liquid crystal display panel according to a second embodiment of the present invention; and

FIG. 7 is a schematic view illustrating step 2 of the manufacturing method of the liquid crystal display panel according to the second embodiment of the present invention.

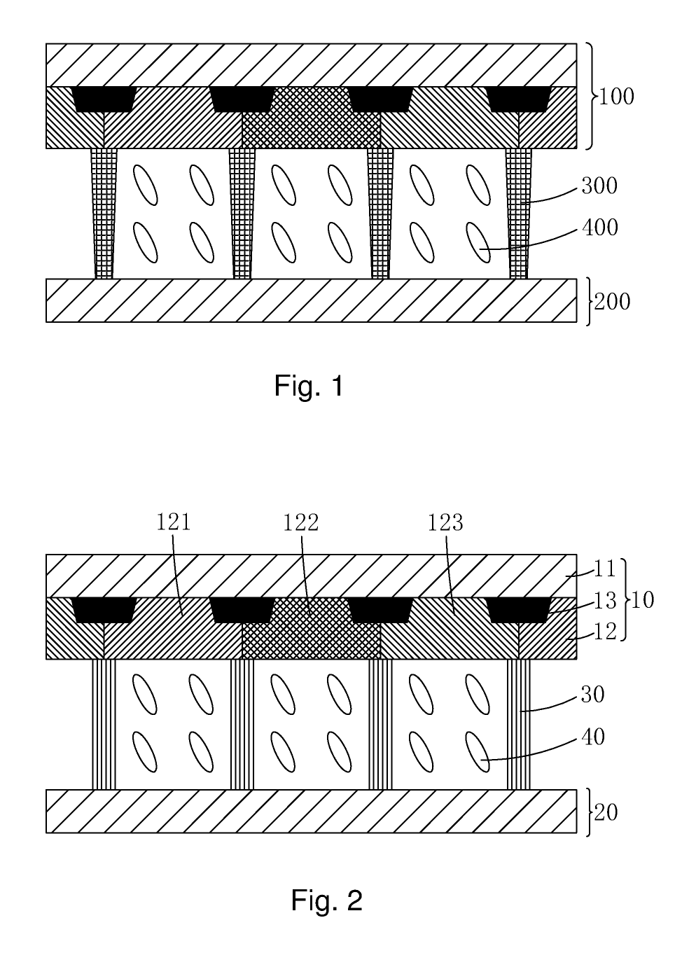

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

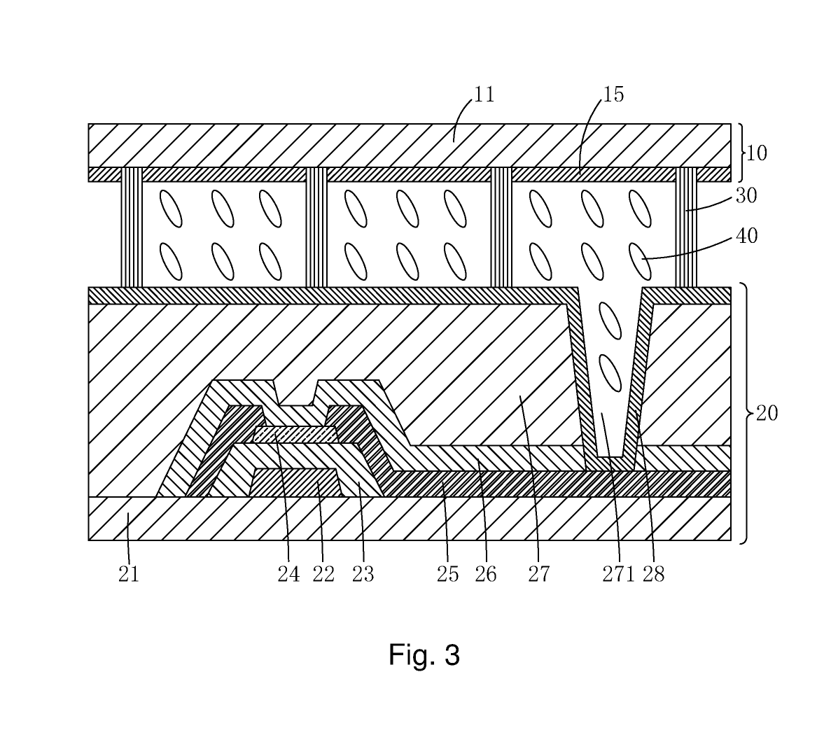

Referring to FIGS. 2-3, the present invention provides a liquid crystal display panel, which comprises an upper substrate 10 and a lower substrate 20 that are arranged opposite to each other, a liquid crystal layer 40 arranged between the upper substrate 10 and the lower substrate 20, and a plurality of spacers 30 arranged between the upper substrate 10 and the lower substrate 20, wherein the spacers 30 are each formed of an aligned carbon nanotube array comprising multiple aligned carbon nanotubes that are arranged parallel to each other.

Specifically, the aligned carbon nanotubes are single-walled carbon nanotubes (SWNTs) or multi-walled carbon nanotubes (MWNTs).

Due to the property and stability of the aligned carbon nanotubes, being resistant to high temperature and hard to react with other substances, and also showing excellent mechanic performance and possessing excellent elastic property of compressibility and restorability, the aligned carbon nanotube array can effectively support the upper and lower substrates 10, 20 and maintain thickness and uniformity of a gap between the upper and lower substrates 10, 20.

FIG. 2 illustrates a first embodiment of the liquid crystal display panel of the present invention. In the first embodiment, the upper substrate 10 comprises a first base plate 11, a black matrix 13 arranged on the first base plate 11, and a color resist layer 12 arranged on the black matrix 13 and the first base plate 11. The color resist layer 12 has a surface that is a flat and smooth surface. The lower substrate 20 is a thin-film transistor array substrate.

Specifically, the first base plate 11 is a transparent plate, and preferably a glass plate.

Specifically, the plurality of spacers 30 is arranged at locations corresponding to the black matrix 13 of the upper substrate 10.

Specifically, the color resist layer 12 comprises a plurality of red photoresist blocks 121, a plurality of blue photoresist blocks 122, and a plurality of green photoresist blocks 123.

FIG. 3 illustrates a second embodiment of the liquid crystal display panel of the present invention. In the second embodiment, the upper substrate 10 comprises a first base plate 11 and a patternized common electrode 15 arranged on the first base plate 11. The plurality of spacers 30 is arranged to contact portions of the first base plate 11 that are not covered by the common electrode 15. The surface of the first base plate 11 that is in contact with the plurality of spacers 30 is a flat and smooth surface. The lower substrate 20 comprises a second base plate 21 and a gate electrode 22, a gate insulation layer 23, an active layer 24, source/drain electrodes 25, a passivation layer 26, a color resist layer 27, and a pixel electrode 28 that are arranged, in sequence from bottom to top, on the second base plate 21, wherein the color resist layer 27 comprises a via 271 formed therein such that the pixel electrode 28 is in contact with the source/drain electrodes 25 through the via 271.

Specifically, the first base plate 11 is a transparent plate, and preferably a glass plate.

Specifically, the lower substrate 20 further comprises a black matrix arranged above or under the color resist layer 27 and the plurality of spacers 30 is arranged at locations corresponding to the black matrix.

Specifically, the color resist layer 27 comprises a plurality of red photoresist blocks, a plurality of blue photoresist blocks, and a plurality of green photoresist blocks. The black matrix is arranged to correspond to an interface between adjacent photoresist blocks.

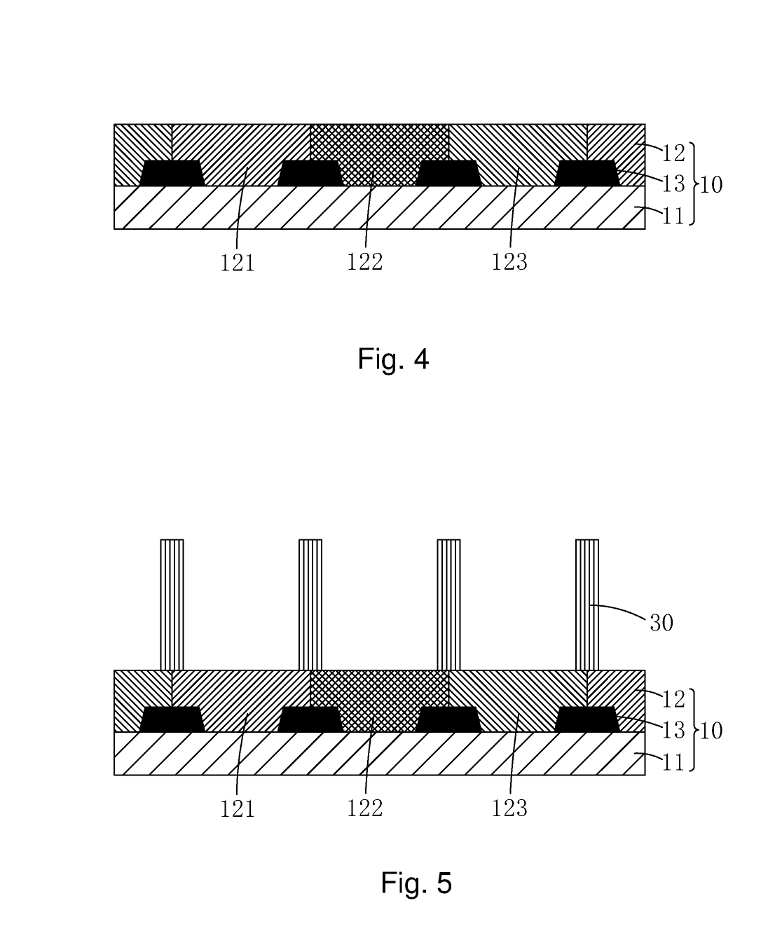

Referring to FIGS. 4-5, in combination with FIG. 2, the present invention also provides a manufacturing method of a liquid crystal display panel, which comprises the following steps:

Step 1: as shown in FIG. 4, providing an upper substrate 10, wherein the upper substrate 10 comprises a first base plate 11, a black matrix 13 arranged on the first base plate 11, and a color resist layer 12 arranged on the black matrix 13 and the first base plate 11, the color resist layer 12 having a surface that is a flat and smooth surface; and the surface of the color resist layer 12 is provided with a plurality of locations for spacers.

Specifically, the first base plate 11 is a transparent plate, and preferably a glass plate.

Specifically, the color resist layer 12 comprises a plurality of red photoresist blocks 121, a plurality of blue photoresist blocks 122, and a plurality of green photoresist blocks 123.

Step 2: as shown in FIG. 5, growing aligned carbon nanotubes on the color resist layer 12 at the plurality of locations for spacers such that in each of the locations for spacers, an aligned carbon nanotube array that comprises multiple parallel aligned carbon nanotubes is formed so as to form a plurality of spacers 30.

Specifically, the aligned carbon nanotubes are single-walled carbon nanotubes (SWNTs) or multi-walled carbon nanotubes (MWNTs).

Specifically, the plurality of spacers 30 is arranged at locations corresponding to the black matrix 13 of the upper substrate 10.

Specifically, in Step 2, a process involving using laser to engrave a base, a plasma enhanced chemical vapor deposition, or metal organic pyrolysis, which are commonly used regular techniques in this field, is applied to grow the aligned carbon nanotubes on the substrate 10.

Step 3: as shown in FIG. 2, providing a lower substrate 20, wherein the lower substrate 20 is a thin-film transistor array substrate; and dripping liquid crystal molecules on a surface of the upper substrate 10 that comprises the plurality of spacers 30 formed thereon or a surface of the lower substrate 20 to form a liquid crystal layer 40 and aligning and laminating the upper substrate 10 and the lower substrate 20 together to form a liquid crystal display panel.

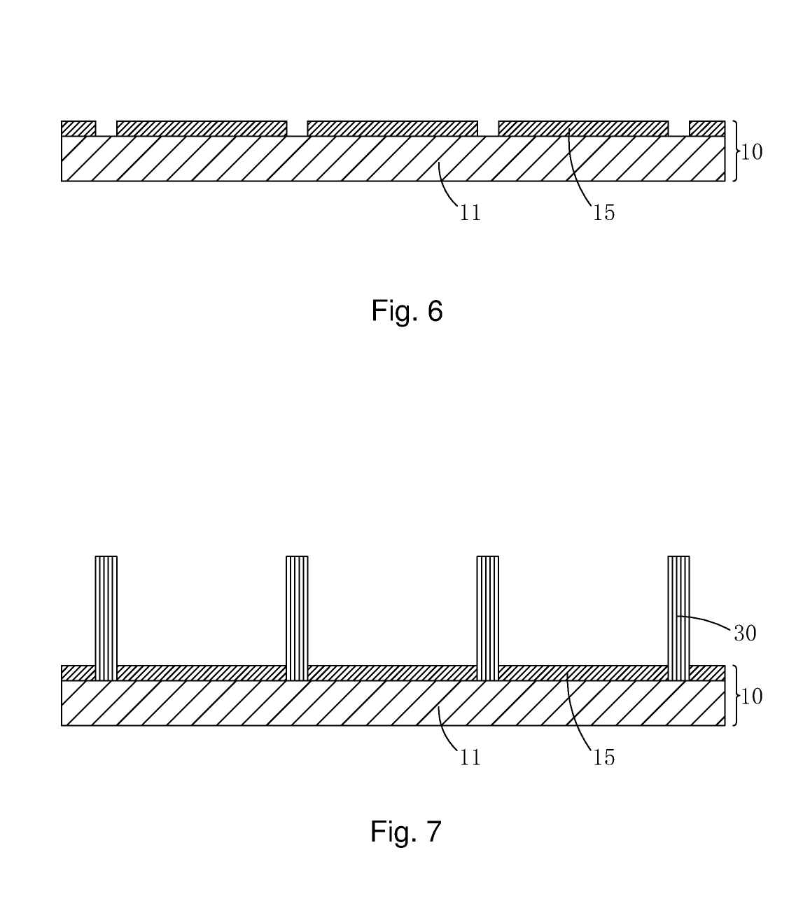

Referring to FIGS. 6-7, in combination with FIG. 3, the present invention also provides another manufacturing method of a liquid crystal display panel, which comprises the following steps:

Step 1: as shown in FIG. 6, providing an upper substrate 10, wherein the upper substrate 10 comprises a first base plate 11 and a patternized common electrode 15 formed on the first base plate 11, a surface of the first base plate 11 that is in contact with the common electrode 15 being a flat and smooth surface, portions of the first base plate 11 that are covered by the common electrode 15 forming a plurality of locations for spacers.

Specifically, the first base plate 11 is a transparent plate, and preferably a glass plate.

Specifically, the common electrode 15 is formed of a material comprising a metal, preferably a metal having good contact surface, such as gold (Au), and to prevent the common electrode 15 that is made of a metal from affecting light transmission rate of a liquid crystal panel, the thickness of the common electrode 15 can be made reduced, such as 10-20 nm.

Step 1 uses the patternized common electrode 15 to define the plurality of locations for spacers on the first base plate 11 and also makes use of the principle that carbon nanotube does not grow on a metal surface to make the aligned carbon nanotubes growing on the plurality of locations for spacers so as to form spacers made up of aligned carbon nanotube arrays.

Step 2: as shown in FIG. 7, growing aligned carbon nanotubes on the first base plate 11 at the plurality of locations for spacers, wherein each of the locations for spacers comprises an aligned carbon nanotube array comprising multiple parallel aligned carbon nanotubes formed thereon so as to form a plurality of spacers 30.

Specifically, the aligned carbon nanotubes are single-walled carbon nanotubes (SWNTs) or multi-walled carbon nanotubes (MWNTs).

Specifically, in Step 2, a process involving using laser to engrave a base, a plasma enhanced chemical vapor deposition, or metal organic pyrolysis, which are commonly used regular techniques in this field, is applied to grow the aligned carbon nanotubes on the substrate 10.

Step 3: as shown in FIG. 3, providing a lower substrate 20, wherein the lower substrate 20 comprises a second base plate 21 and a gate electrode 22, a gate insulation layer 23, an active layer 24, source/drain electrodes 25, a passivation layer 26, a color resist layer 27, and a pixel electrode 28 that are arranged, in sequence from bottom to top, on the second base plate 21, wherein the color resist layer 27 comprises a via 271 formed therein such that the pixel electrode 28 is in contact with the source/drain electrodes 25 through the via 271.

Liquid crystal molecules are dripped on a surface of the upper substrate 10 that comprises the plurality of spacers 30 formed thereon or a surface of the lower substrate 20 that comprises the pixel electrode 28 formed thereon to form a liquid crystal layer 40 and the upper substrate 10 and the lower substrate 20 are aligned and laminated together to form a liquid crystal display panel.

Specifically, the lower substrate 20 further comprises a black matrix arranged above or under the color resist layer 27 and the plurality of spacers 30 is arranged at locations corresponding to the black matrix.

Specifically, the color resist layer 27 comprises a plurality of red photoresist blocks, a plurality of blue photoresist blocks, and a plurality of green photoresist blocks. The black matrix is arranged to correspond to an interface between adjacent photoresist blocks.

In summary, the present invention provides a liquid crystal display panel, which comprises aligned carbon nanotube arrays to replace photo spacers that are used in the prior art and takes advantage of the excellent mechanic property and excellent stability of the aligned carbon nanotubes to significantly enhance the performance and service life of a liquid crystal display panel. The present invention also provides a manufacturing method of a liquid crystal display panel, which grows aligned carbon nanotubes on one substrate of a liquid crystal display panel to obtain spacers formed of aligned carbon nanotube arrays, so as to take advantage of the excellent mechanic property and excellent stability of the aligned carbon nanotubes to significantly enhance the performance and service life of a liquid crystal display panel.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal display panel, comprising an upper substrate and a lower substrate arranged opposite to each other, a liquid crystal layer arranged between the upper substrate and the lower substrate, and a plurality of spacers arranged between the upper substrate and the lower substrate, wherein the spacers are each formed of an aligned carbon nanotube array comprising multiple aligned carbon nanotubes that are arranged parallel to each other.

2. The liquid crystal display panel as claimed in claim 1, wherein the aligned carbon nanotubes are single-walled carton nanotubes or a multi-walled carbon nanotubes.

3. The liquid crystal display panel as claimed in claim 1, wherein the upper substrate comprises a first base plate, a black matrix arranged on the first base plate, and a color resist layer arranged on the black matrix and the first base plate, the color resist layer having a surface that is a flat and smooth surface, the lower substrate being a thin-film transistor array substrate.

4. The liquid crystal display panel as claimed in claim 1, wherein the upper substrate comprises a first base plate and a patternized common electrode arranged on the first base plate, the plurality of spacers being arranged to contact portions of the first base plate that are not covered by the common electrode, the surface of the first base plate that is in contact with the plurality of spacers being a flat and smooth surface, the lower substrate comprising a second base plate and a gate electrode, a gate insulation layer, an active layer, source/drain electrodes, a passivation layer, a color resist layer, and a pixel electrode that are arranged, in sequence from bottom to top, on the second base plate.

5. A manufacturing method of a liquid crystal display panel, comprising the following steps:
(1) providing a upper substrate, wherein the upper substrate comprises a first base plate, a black matrix arranged on the first base plate, and a color resist layer arranged on the black matrix and the first base plate, the color resist layer having a surface that is a flat and smooth surface; and the surface of the color resist layer is provided with a plurality of locations for spacers;
(2) growing aligned carbon nanotubes on the color resist layer at the plurality of locations for spacers such that in each of the locations for spacers, an aligned carbon nanotube array that comprises multiple parallel aligned carbon nanotubes is formed so as to form a plurality of spacers; and
(3) providing a lower substrate, wherein the lower substrate is a thin-film transistor array substrate; and dripping liquid crystal molecules on a surface of the upper substrate that comprises the plurality of spacers formed thereon or a surface of the lower substrate to form a liquid crystal layer and aligning and laminating the upper substrate and the lower substrate together to form a liquid crystal display panel.

6. The manufacturing method of the liquid crystal display panel as claimed in claim 5, wherein the aligned carbon nanotubes are single-walled carton nanotubes or a multi-walled carbon nanotubes.

7. The manufacturing method of the liquid crystal display panel as claimed in claim 5, wherein the plurality of spacers is arranged at locations corresponding to the black matrix of the upper substrate.

8. A manufacturing method of a liquid crystal display panel, comprising the following steps:
(1) providing a upper substrate, wherein the upper substrate comprises a first base plate and a patternized common electrode formed on the first base plate, a surface of the first base plate that is in contact with the common electrode being a flat and smooth surface, portions of the first base plate that are covered by the common electrode forming a plurality of locations for spacers;
(2) growing aligned carbon nanotubes on the first base plate at the plurality of locations for spacers, wherein each of the locations for spacers comprises an aligned carbon nanotube array comprising multiple parallel aligned carbon nanotubes formed thereon so as to form a plurality of spacers; and
(3) providing a lower substrate, wherein the lower substrate comprises a second base plate and a gate electrode, a gate insulation layer, an active layer, source/drain electrodes, a passivation layer, a color resist layer, and a pixel electrode that are arranged, in sequence from bottom to top, on the second base plate;
wherein liquid crystal molecules are dripped on a surface of the upper substrate that comprises the plurality of spacers formed thereon or a surface of the lower substrate that comprises the pixel electrode formed thereon to form a liquid crystal layer and the upper substrate and the lower substrate are aligned and laminated together to form a liquid crystal display panel.

9. The manufacturing method of the liquid crystal display panel as claimed in claim 8, wherein the aligned carbon nanotubes are single-walled carton nanotubes or a multi-walled carbon nanotubes.

10. The manufacturing method of the liquid crystal display panel as claimed in claim 8, wherein the common electrode is formed of a material comprising a metal; the lower substrate further comprises a black matrix arranged above or under the color resist layer; and the plurality of spacers is arranged at locations corresponding to the black matrix.
